(19) United States
(12) Patent Application Publication
(10) Pub. No.: US 2019/0128066 A1
(43) Pub. Date: May 2, 2019

(54) Ladder Safety Device

(71) Applicants: Michael Tombragel, Cincinnati, OH (US); Stephen Tombragel, Cincinnati, OH (US); Aerin Shaw, Cincinnati, OH (US)

(72) Inventors: Michael Tombragel, Cincinnati, OH (US); Stephen Tombragel, Cincinnati, OH (US); Aerin Shaw, Cincinnati, OH (US)

(21) Appl. No.: 16/171,876

(22) Filed: Oct. 26, 2018

Related U.S. Application Data
(60) Provisional application No. 62/579,193, filed on Oct. 31, 2017.

(51) Int. Cl. E06C 7/46

(52) U.S. Cl. CPC E06C 7/46

(57) ABSTRACT

A ladder safety device is provided for securing a ladder on a surface. The device includes a body having a front side and a bottom, a rigid reinforcement member extending laterally from the bottom of the body and configured to establish contact with the surface, and at least one anchor extending downward from the bottom of the body and configured to engage the surface when the rigid reinforcement member establishes contact with the surface, such that the body reinforces and restricts movement of the ladder supported by the surface when the front side of the body abuts at least one rail of the ladder, the rigid reinforcement member is in contact with the surface, and the at least one anchor engages the surface.

### CROSS REFERENCE TO RELATED APPLICATION

This application claims priority to U.S. Provisional Patent Application No. 62/579,193, filed Oct. 31, 2017, entitled “Ladder Safety Device,” the entire disclosure of which is hereby incorporated by reference.

### BACKGROUND

### 1. Field

This invention relates generally to ladders and, in particular embodiments, to a ladder safety device and method for securing a ladder to a surface.

### 2. Technical Considerations

Each year over 164,000 people visit emergency rooms in the USA for injuries resulting from falls from ladders. Over the past decade accidental deaths have tripled with fatalities surpassing 300 victims each year. Falls from ladders are known to be the leading cause of death on construction sites. This is particularly acute for construction workers using extension ladders outdoors on soft ground or on smooth/slippery surface decks. (Source: International Association of Home Inspectors. Gramiko and Shepherd. https://www.nachi.org/ladder-safety.htm)

A straight ladder or extension ladder is used by placing the two lower-end feet on the ground or deck and leaning the ladder against the object being worked on, such as a house. The sagital backforce becomes increasingly greater as a worker ascends the ladder, and unless the ladder's feet are firm and secure, the sagital backforce (or Y-axis displacement force) can cause the ladder to “lose its footing” and slip out away from the building or wall, causing a sudden and dangerous fall. There are many devices that attempt to stabilize or anchor ladders as seen in the references cited below, but none provide the advantages of non-limiting embodiments of the ladder safety device and method described herein.

The prior art may be broken down into three categories. The first category includes devices that affix to the ladder itself, such as in U.S. Pat. Nos. 9,068,395, 6,167,989, 4,641,729, and 4,519,477. These devices are demonstrably different than the ladder safety device presented herein because they are an integral part of the ladder itself.

The second category of prior art includes devices affixed to the ladder that provide movable support, such as rail devices, U-brackets that are affixed to the ladder, or aerial pulley systems that secure the ladder from its top side. This category includes U.S. Pat. Nos. 9,488,001, 9,447,639, and 9,284,777.

The third category includes independent anchors or pins, but they often require separate pins for each foot of the ladder, and also require affixing the ladder after the pin is inserted into the ground. This makes commercial use impractical given the time it takes for multi-pin insertion and securing the ladder to the pin. The references in this third category are U.S. Pat. Nos. 8,887,867, 8,464,834, and 5,337,856.

U.S. Pat. No. 776,446 attempts to provide an independent anchor that is simple to use but the device described therein requires affixing each end to the ladder feet by a screw mechanism. Further, the support into the ground is a hand-turned screw that requires a turning motion, which is very difficult to accomplish in certain surfaces such as hard dirt.

### SUMMARY

According to non-limiting embodiments, provided is a ladder reinforcement safety device for securing a ladder on a surface, comprising: a body having a front side and a bottom, the body being separate from a ladder; a rigid reinforcement member extending laterally from the bottom of the body and configured to establish contact with the surface; and at least one anchor extending downward from the bottom of the body and configured to engage the surface when the rigid reinforcement member establishes contact with the surface, such that the body reinforces and restricts movement of the ladder supported by the surface when the front side of the body abuts at least one rail of the ladder, the rigid reinforcement member is in contact with the surface, and the at least one anchor engages the surface.

In some non-limiting embodiments, the front side has a length extending a width of a ladder. In some examples, the length is greater than 16 inches. Further, in some non-limiting embodiments, the rigid reinforcement member comprises a plate extending from a back side of the body and in a direction opposite the front side of the body. In some examples, the plate is bent at a substantially 90 degree angle, wherein a first portion of the plate is parallel and secured to the front side or back side of the body, and wherein a second portion of the plate extends laterally from the bottom of the body such that the rigid reinforcement plate is substantially perpendicular to a vertical axis of the body. The body may include a handle in some non-limiting embodiments.

In non-limiting embodiments, the ladder safety device includes at least two fenders secured to or integral with the body and extending from the front side of the body, wherein a space between the at least two fenders receives the ladder such that the at least two fenders restrict lateral movement of the ladder. In non-limiting embodiments, the at least one anchor comprises at least two tongs configured to engage the surface by fitting between deck boards of the surface or being inserted into the surface. In non-limiting embodiments, the body further comprises a top side opposite the bottom side, wherein at least one hammer plate is arranged on the top side of the body. In non-limiting embodiments, the at least one hammer plate is integral with a top end of the at least one anchor. In non-limiting embodiments, the body comprises at least one vertical channel including an aperture on a top side of the body and an aperture on the bottom side of the body, wherein the at least one vertical channel receives the at least one anchor. In non-limiting embodiments, the at least one anchor is integral to the body. In non-limiting embodiments, the rigid reinforcement member is integral to the body. In non-limiting embodiments, the rigid reinforcement member comprises an L-shaped bracket comprising a vertical portion and a horizontal portion, wherein the vertical portion is attached to the front side or a back side of the body, and wherein the horizontal portion extends from the body and is configured to contact the surface.

According to another non-limiting embodiment, provided is a method for securing a ladder on a surface, the ladder having a base and two rails separated by a width, the method including: (a) leaning the ladder against an object, such that the base of the ladder is in contact with the surface, the base of the ladder having a front side facing the object and a back side facing away from the object; (b) placing a ladder safety device against the back side of the base of the ladder, the ladder safety device comprising: (i) a body having a length greater than the width separating the two rails of the ladder, and (ii) at least one anchor extending downward from the body; and (c) securing the at least one anchor to the surface by: (i) inserting the at least one anchor between two boards of the surface or (ii) inserting the at least one anchor into the surface.

In non-limiting embodiments, the method further includes hammering at least one hammer plate arranged on a top side the body to secure the at least one anchor to the surface. In non-limiting embodiments, the ladder safety device comprises a rigid reinforcement member extending laterally from a bottom of the body, and placing the ladder safety device against the back side of the base of the ladder comprises arranging the rigid reinforcement member to establish contact with the surface.

According to another non-limiting embodiment, provided is a ladder safety device for securing a ladder on a surface, including a body; and at least one anchor extending downward from the body such that the at least one anchor is substantially perpendicular to the surface when the body is placed against a base of the ladder and restricts the ladder from moving on the surface.

In non-limiting embodiments, the ladder safety device also includes a rigid reinforcement member extending laterally from a bottom of the body and configured to establish contact with the surface. In non-limiting embodiments, the at least one anchor and the rigid reinforcement member are substantially perpendicular. In non-limiting embodiments, the at least one anchor comprises at least two tongs, each tong of the at least two tongs having a thickness less than ⅛ inch and configured to fit between two boards of a deck.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a,” “an,” and “the” include plural referents unless the context clearly dictates otherwise.

### BRIEF DESCRIPTION OF THE DRAWINGS

Additional advantages and details of non-limiting embodiments are explained in greater detail below with reference to the accompanying schematic figures, in which:

FIG. 1 is a front perspective view of a ladder safety device according to non-limiting embodiments;

FIG. 2 is a back perspective view of a ladder safety device according to non-limiting embodiments;

FIG. 3 is a side view of a ladder safety device being used with a ladder according to non-limiting embodiments;

FIG. 4 is a side view of a ladder safety device being used with a ladder according to non-limiting embodiments;

FIG. 5 is a front perspective view of a ladder safety device according to non-limiting embodiments; and

FIG. 6 is a back perspective view of a ladder safety device according to non-limiting embodiments.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

Non-limiting embodiments are directed to a ladder safety device that prevents a ladder from slipping or moving on a surface, such as the ground or a deck surface. The ladder safety device may be placed on the surface and against two rails (e.g., legs) of a ladder to provide safety and stability to a user of the ladder. In non-limiting embodiments, the ladder safety device is separate from and independent from the ladder and does not require physical attachment to the ladder. Accordingly, non-limiting embodiments of the ladder safety device are portable and can be used with a variety of different ladders. Further, non-limiting embodiments of the ladder safety device allow for a ladder to be secured to a surface temporarily and without requiring screws, bolts, or other time-consuming hardware. It will be appreciated that various other benefits are possible.

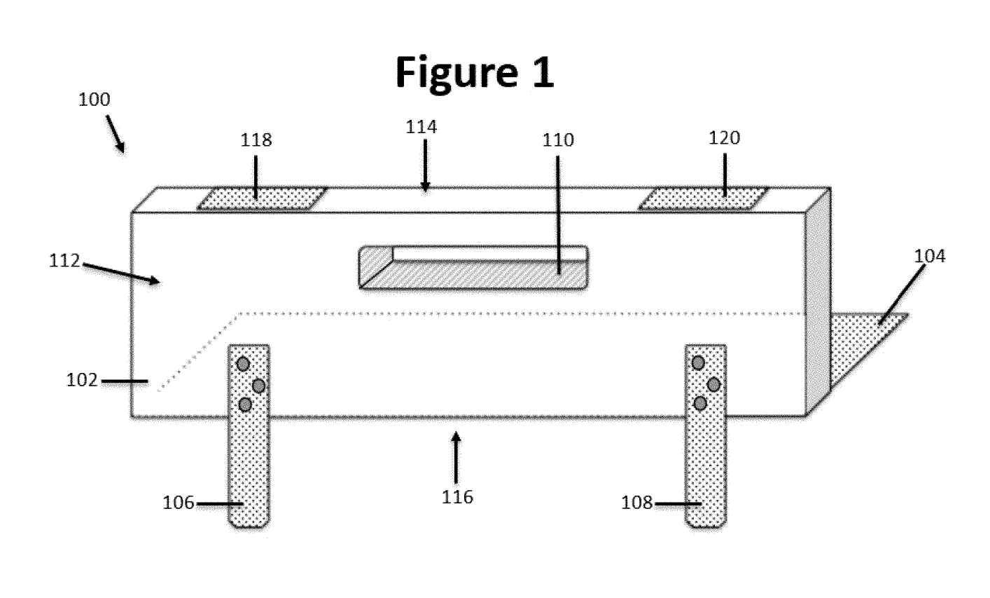

FIG. 1 shows a ladder safety device 100 according to a non-limiting embodiment. The ladder safety device 100 includes a body 102 having a front side 112, top side 114, bottom side 116, and back side (not shown in FIG. 1). FIG. 1 depicts a non-limiting embodiment in which the length of the body 102 is the longest dimension, the height the second longest dimension, and the width the shortest dimension. In other non-limiting embodiments, the width of the body 102 may be the longest dimension, the length the second longest dimension, and the height the shortest dimension. Any combination of the length, width, and height may be used. In a non-limiting embodiment, the length of the body 102 is 22 inches (e.g., greater than the width of many ladders), the height is 4 inches, and the width is 1 inch. In the example shown in FIG. 1, the body 102 is a rectangular block, although it will be appreciated that the body 102 may be shaped in various ways. The body may be made of wood, plastic, metal, or any other suitable material or combination of such materials.

Still referring to FIG. 1, in non-limiting embodiments, the ladder safety device 100 includes at least one rigid reinforcement member 104 (partially shown in FIG. 1) that extends laterally from the bottom side 116 of the body 102 such that the rigid reinforcement member 104 is configured to make contact with a surface (not shown in FIG. 1). In a non-limiting embodiment, the rigid reinforcement member is attached to the back side (not shown in FIG. 1) of the body 102. In other non-limiting embodiments, the rigid reinforcement member 104 may be integral to the body 102 as to form one unit. In other non-limiting embodiments, the rigid reinforcement member may be an L-shaped bracket where one side contacts the back side (not shown in FIG. 1) or the front side 112 of the body 102 and the other side contacts the surface (not shown in FIG. 1).

It will be appreciated that the rigid reinforcement member 104 may be shaped in various ways. In non-limiting embodiments, for example, the rigid reinforcement member may be a triangular block that is attached or integral to the body 102 and contacts the surface. The rigid reinforcement member 104 extends away from the body 102 such that it is substantially perpendicular to a vertical axis, or height, of the body 102. The rigid reinforcement member 104 may be made of wood, plastic, metal, or any suitable material or combination of such materials. In non-limiting embodiments, the rigid reinforcement member 104 may be 12 inches long or may be as long as the length of the body 102. However, it will be appreciated that the rigid reinforcement member 104 may be of various dimensions and/or that multiple rigid reinforcement members 104 may be used along the length of the body 102. In non-limiting embodiments, any number of rigid reinforcement members 104 are attached to or integral with the body 102.

With continued reference to FIG. 1, the ladder safety device 100 may also include one or more anchors 106, 108 configured to engage a surface (not shown in FIG. 1) such as the ground or a deck surface. For example, the anchors 106, 108 may be inserted into the ground (e.g., earth) or between deck boards. The non-limiting embodiment in FIG. 1 depicts two anchors 106, 108, although it will be appreciated that any number of anchors may be used. Although a single anchor 106 may be used in non-limiting embodiments, preferably two or more anchors 106, 108 are used to provide increased support and stability. The anchor 106 may have a length that is as long as the length of the body 102 or shorter than the length of the body 102, a height of any dimension, and a width of any dimension. For example, in non-limiting embodiments, the anchor extends 6 inches away from the body. The non-limiting embodiment in FIG. 1 depicts the anchors 106, 108 to be flat, rigid members that are attached to the body 102 in a spaced arrangement. The anchors 106, 108 may be made of wood, plastic, metal, or other suitable material or combination of such materials.

In non-limiting embodiments, and still referring to FIG. 1, the anchors 106, 108 may be attached to the body 102 or integral with the body 102. In non-limiting embodiments, for example, the body 102, rigid reinforcement member 104, and/or one or more anchors 106, 108 may be integral to form a unitary device. In non-limiting embodiments, the rigid reinforcement member 104 and anchors 106, 108 may be integral such that the portion of the rigid reinforcement member 104 that contacts the body 102 extends past the bottom side 116 of the body 102 that contacts the surface so as to serve as an anchor. In other non-limiting embodiments, the anchors 106, 108 may be affixed to the body 102 with nails, screws, bolts, glue, or any other attachment means. In another non-limiting embodiment, the anchors 106, 108 may be in a different shape, such as a cone, prism, or triangle. In a non-limiting embodiment, the anchors 106, 108 may be attached to the front side 112 of the body 102, although it is appreciated that the anchors 106, 108 may be attached to any side of the body 102 so long as they are positioned to extend downward toward the surface on which the ladder will be placed. In non-limiting embodiments, the anchors 106, 108 may be attached to the top side 114 of the body and generally extend downwards to be inserted into the ground or between deck boards. The non-limiting embodiment shown in FIG. 1 illustrates the anchors 106, 108 as being substantially flat such that they can fit in a gap between boards (e.g., less than ⅛ inch thick, although various thicknesses are possible based on the gap size). The anchors 106, 108 shown in the example in FIG. 1 are positioned so as to fit between deck boards that run parallel to the length of the body 102. It will be appreciated that the anchors 106, 108 may be positioned or may be adjustable to be turned from the embodiment shown in FIG. 1 such that they fit between deck boards that run at other angles with respect to the length of the body 102.

Still referring to FIG. 1, non-limiting embodiments of the ladder safety device 100 include a handle 110. In non-limiting embodiments, the handle 100 is a cavity in the body 102 where a user may grip the ladder safety device 100 by inserting the user's hand through the opening. In non-limiting embodiments, the length of the handle 110 may be 5.5 inches long and rectangular, although any size and/or shape is possible. In non-limiting embodiments, the handle 110 may be a separate unit attached to the body 102, unlike the integral handle 110 shown in FIG. 1. Various other arrangements are possible.

With continued reference to FIG. 1, in non-limiting embodiments, the ladder safety device 100 includes at least one hammer plate 118, 120 on the top side 114 of the body 102. The example shown in FIG. 1 includes two hammer plates 118, 120, although it will be appreciated that any number may be used and that, in other non-limiting embodiments, a hammer plate may not be utilized. It will be appreciated that the width of the hammer plates 118, 120 may be shorter than the width of the body 102 or longer than width of the body 102 as to extend outwards or fold over onto the front side 112 and/or the back side (not shown in FIG. 1) of the body 102. In non-limiting embodiments, the length of the hammer plates 118, 120 is shorter than the length of the body 102, although it is appreciated that the length of the hammer plates 118, 120 may be longer than the length of the body 102 so as to extend outwards or fold over onto the sides of the body 102. The hammer plates 118, 120 may be made of wood, plastic, metal, or any suitable material or combination of such materials. In non-limiting embodiments, the hammer plates 118, 120 may be integral to the body 102. In non-limiting embodiments the hammer plates may be rectangular units, although it is appreciated that the hammer plates may be different shapes. Moreover, in non-limiting embodiments, the hammer plates 118, 120 may be integral with anchors 106, 108 such that the hammer plates 118, 120 form a top portion of the elongated anchors 106, 108. In non-limiting embodiments, the hammer plates 118, 120 are used to strike a hammer or mallet against to drive the anchors 108, 106 into the ground or between boards.

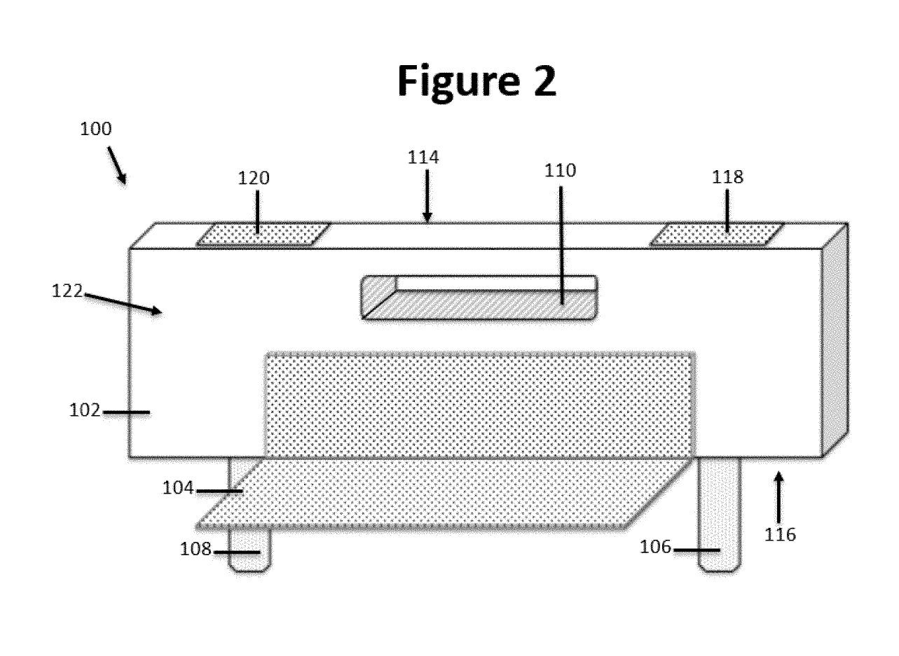

FIG. 2 illustrates the ladder reinforcement safety device 100 from a back view in which a back side 122 of the body 102 is shown. As discussed above and shown in more detail in FIG. 2, in non-limiting embodiments the rigid reinforcement member 104 may be attached to the back side 122 of the body 102. In non-limiting embodiments, a portion of the rigid reinforcement member 104 that is attached to the back side 122 of the body 102 may be shorter than the height of the body 102. For example, the portion of the rigid reinforcement member 104 that is attached to the back side 122 of the body 102 and the portion that extends away from the body may each be 2 inches. In other non-limiting embodiments, a portion of the rigid reinforcement member 104 that is attached to the back side 122 of the body 102 may be longer than the height of the body 102 such that the portion that extends beyond the body 102 folds over onto the top side 114 of the body to function as hammer plates 118, 120. In non-limiting embodiments, the length of the portion of the rigid reinforcement member 104 that is attached to the back side 112 of the body 102 may be shorter than the portion of the rigid reinforcement member 104 that is in contact with the surface. In other non-limiting embodiments, the portion of the rigid reinforcement member 104 that is attached to the back side 122 of the body 102 may be longer than the portion of the rigid reinforcement member 104 that is in contact with the surface. The rigid reinforcement member 104 shown in FIG. 2 is L-shaped such that the back side 122 of the body 102 provides leverage to support the body 102 perpendicular to the portion of the reinforcement member 104 that contacts the surface.

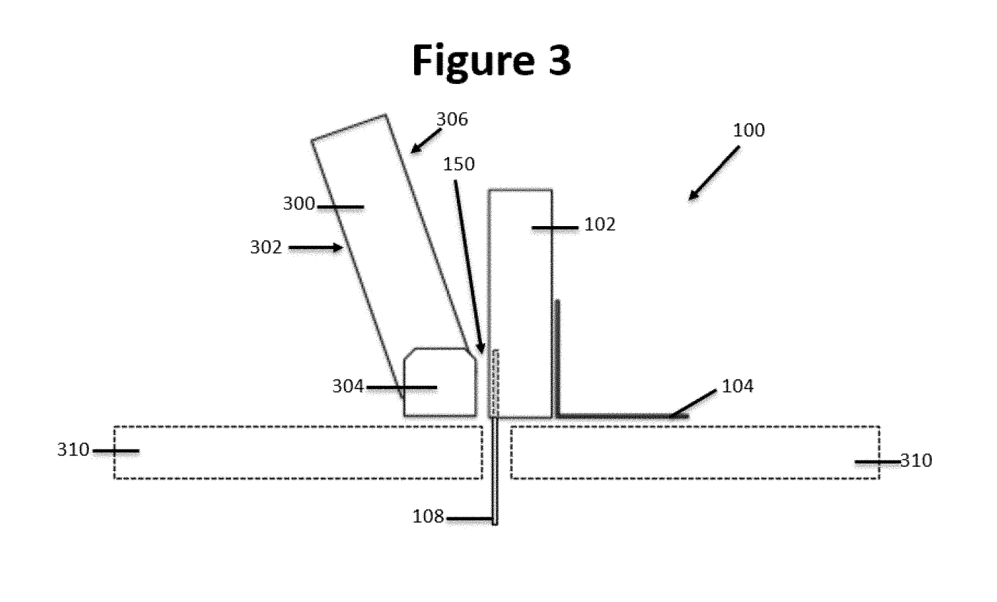

Referring now to FIG. 3, shown is a non-limiting embodiment of a ladder safety device 100 in use. In this non-limiting embodiment, the ladder reinforcement safety device 100 is supporting a ladder 300. In the example shown, a backstop 150 is a portion of the front side of the body 102 that touches the ladder 300. The ladder has a base 304 that contacts the surface 310 and the backstop 150. As shown, the anchor 108 is inserted in a surface 310 that includes a gap between two boards. The anchor 108 is shown as being inserted into a channel or cavity on the bottom side of the body 102. In non-limiting embodiments, the anchor may be separated from the body 102 for ease of storage.

With continued reference to FIG. 3, the ladder 300 has a front side 302 and a back side 306 such that the front side 302 of the ladder 300 is facing the object against which the ladder is leaning (e.g., a wall). In other non-limiting embodiments, the ladder may be a step-ladder that does not lean against an object but still benefits from stabilization with the ladder safety device 100. The ladder safety device 100 is placed on the surface 310 such that the back side 306 of the ladder 300 is in contact with the backstop 150 of the body 102. In other methods of using the ladder safety device, the ladder safety device 100 may placed on the surface 310 first, then the ladder 300 is setup such that the back side 306 of the ladder 300 is in contact with the backstop 150 of the body 102. After placing the ladder safety device 100 on the surface 310, in non-limiting embodiments, the anchors of the ladder safety device 100 may be driven into the ground or between boards by striking the hammer plates (not shown in FIG. 3). In non-limiting uses, the ladder safety device may be hammered into the ground by stomping or stepping on the hammer plates or the body 102.

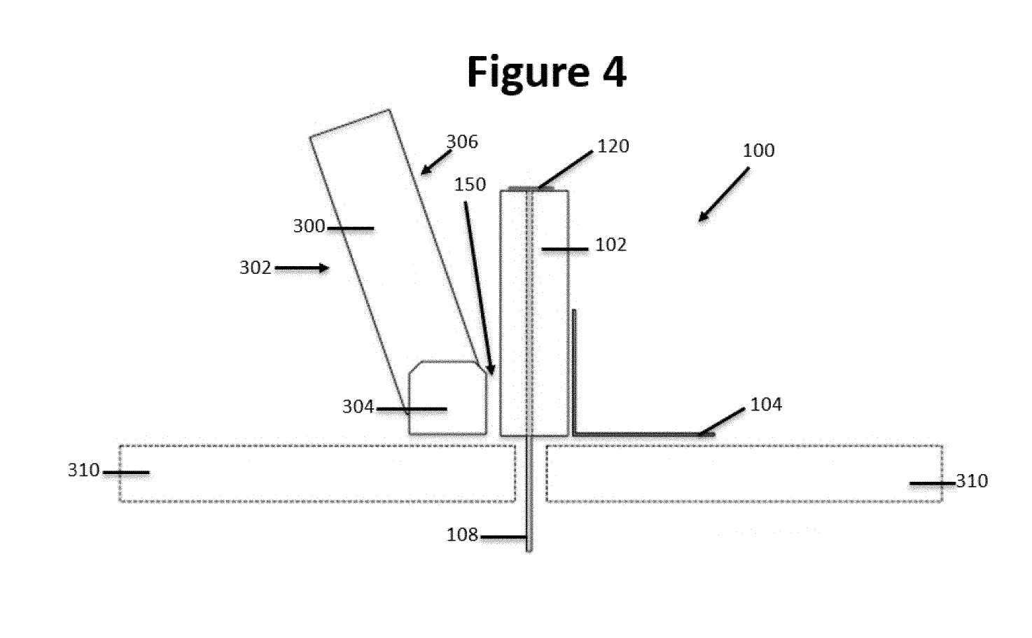

Referring now to FIG. 4, a non-limiting embodiment of the ladder safety device 100 is shown where the at least one anchor 108 protrudes from the top side and the bottom side of the body 102. The anchor 108 extends through the body 102 and is shown as being integral with the at least one hammer plate 120. The anchor 108 may be removable such that it can be inserted into the body 102 of the ladder safety device 100 and driven into the surface 310. In other non-limiting embodiments, the anchor 108 may be fixed within the body 102 of the ladder safety device 100.

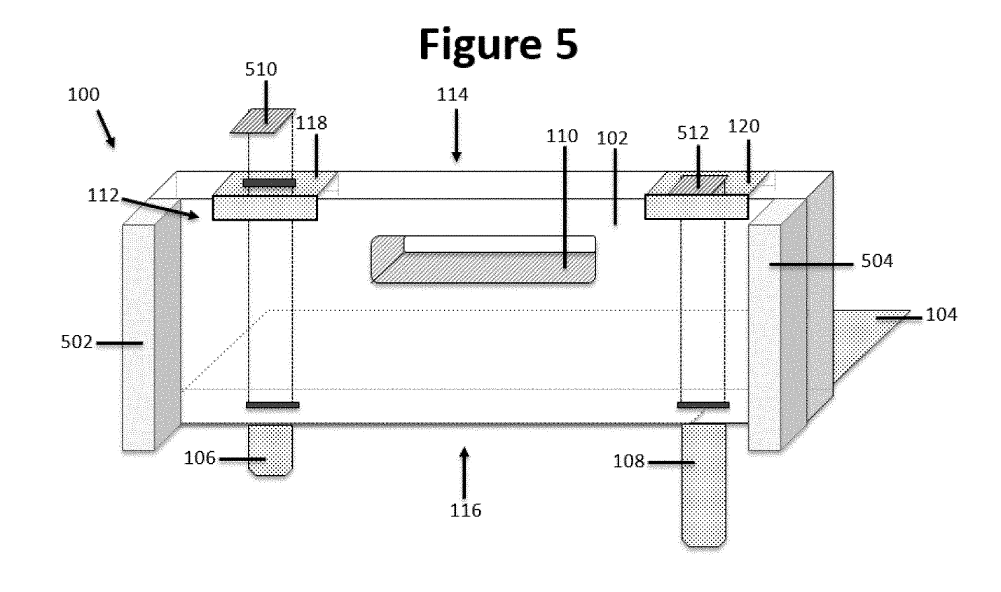

Referring now to FIG. 5, shown is a non-limiting embodiment of a ladder safety device 100 including fenders 502, 504. In this non-limiting embodiment, there are two fenders 502, 504 attached to the front side 112 of the body 102. In other non-limiting embodiments, the fenders 502, 504 may be integral with the body 102. In non-limiting embodiments, the fenders 502, 504 may be rectangular or shaped in any other manner. The height of the fenders 502, 504 shown in FIG. 5 is the height of the body 102, although it is appreciated that the height of the fenders 502, 504 may be longer or shorter than the body 102. In non-limiting embodiments, the fenders 502, 504 may extend from the body 102 by 2 inches and may be 0.5 inches wide, although various dimensions are possible. The fenders 502, 504 may be made of wood, plastic, metal, or any suitable material or combination of such materials. In non-limiting embodiments, the fenders 502, 504 are arranged and spaced apart so as to hold a ladder in place by preventing or limiting lateral movement. For example, a space between the fenders 502, 504 may be equal to or greater than a width of a ladder (e.g., width of rungs in addition to width of rails). Rungs may be, for example, sixteen inches wide and rails may be 1 to 2 inches wide. Accordingly, the space between the fenders 502, 504 may be greater than sixteen inches. In other non-limiting embodiments, the fenders 502, 504 may be spaced and arranged so as to fit inside the rails of a ladder and prevent or limit lateral movement in that manner. Other arrangements are possible.

With continued reference to FIG. 5, the anchors 106,108 are shown as being integral with top surfaces 510, 512. The top surfaces 510, 512 are integral to anchors 106, 108 such that the top surfaces 510, 512 are substantially parallel to the hammer plates 118, 120. In non-limiting embodiments, the top surfaces 510, 512 are flat metal surfaces, although it is appreciated that the top surfaces 510, 512 may be made of wood, plastic, metal, or any suitable material or combination of such materials. In the example shown in FIG. 5, the hammer plates 118, 120 are affixed to the body 102 and include apertures through which the anchors 106, 108 are inserted. Channels running through the body 102 receive the anchors 106, 108. Apertures on the bottom side 116 of the body 102 allow for the anchors 106, 108 to extend through the channel in the body 102 to secure the ladder safety device 100 to a surface.

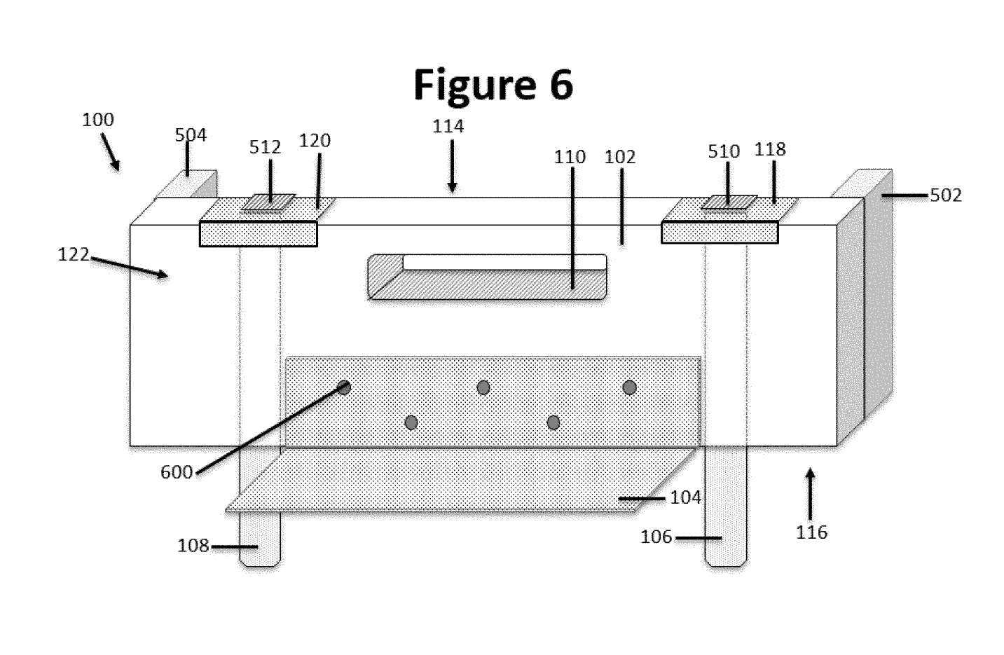

FIG. 6 depicts a back side 122 of the non-limiting embodiment of the ladder safety device 100 shown in FIG. 5. In the depicted example, a screw or bolt 600 affixes the rigid reinforcement member 104 to the body 102, although it will be appreciated that any attachment means may be used.

Although the ladder safety device has been described in detail for the purpose of illustration based on what is currently considered to be the most practical and preferred embodiments, it is to be understood that such detail is solely for that purpose and that the ladder safety device is not limited to the disclosed embodiments, but, on the contrary, is intended to cover modifications and equivalent arrangements that are within the spirit and scope of the appended claims. For example, it is to be understood that, to the extent possible, one or more features of any embodiment can be combined with one or more features of any other embodiment.

The invention claimed is:

1. A ladder safety device for securing a ladder on a surface, comprising:
a body having a front side and a bottom, the body being separate from a ladder;
a rigid reinforcement member extending laterally from the bottom of the body and configured to establish contact with the surface; and
at least one anchor extending downward from the bottom of the body and configured to engage the surface when the rigid reinforcement member establishes contact with the surface, such that the body reinforces and restricts movement of the ladder supported by the surface when the front side of the body abuts at least one rail of the ladder, the rigid reinforcement member is in contact with the surface, and the at least one anchor is in engagement with the surface.

2. The ladder safety device of claim 1, wherein the front side of the body has a length greater than 16 inches.

3. The ladder safety device of claim 1, wherein the rigid reinforcement member comprises a plate extending from a back side of the body and in a direction opposite the front side of the body.

4. The ladder safety device of claim 1, wherein the at least one anchor is substantially perpendicular to the rigid reinforcement member.

5. The ladder safety device of claim 1, further comprising at least two fenders secured to or integral with the body and extending from the front side of the body, wherein a space between the at least two fenders receives the ladder such that the at least two fenders restrict lateral movement of the ladder.

6. The ladder safety device of claim 1, wherein the at least one anchor comprises at least two tongs configured to engage the surface by fitting between deck boards of the surface or being inserted into the surface.

7. The ladder safety device of claim 1, wherein the body further comprises a top side opposite the bottom side, wherein at least one hammer plate is arranged on the top side of the body.

8. The ladder safety device of claim 7, wherein the at least one hammer plate is integral with a top end of the at least one anchor.

9. The ladder safety device of claim 1, wherein the body comprises at least one vertical channel including an aperture on a top side of the body and an aperture on the bottom side of the body, wherein the at least one vertical channel receives the at least one anchor.

10. The ladder safety device of claim 1, wherein the at least one anchor is integral to the body.

11. The ladder safety device of claim 1, wherein the rigid reinforcement member is integral to the body.

12. The ladder safety device of claim 1, wherein the rigid reinforcement member comprises an L-shaped bracket comprising a vertical portion and a horizontal portion, wherein the vertical portion is attached to the front side or a back side of the body, and wherein the horizontal portion extends from the body and is configured to contact the surface.

13. The ladder safety device of claim 1, further comprising a handle.

14. A method for securing a ladder on a surface, the ladder having a base and two rails separated by a width, the method comprising:
(a) leaning the ladder against an object, such that the base of the ladder is in contact with the surface, the base of the ladder having a front side facing the object and a back side facing away from the object;
(b) placing a ladder safety device against the back side of the base of the ladder, the ladder safety device comprising: (i) a body having a length greater than the width separating the two rails of the ladder, and (ii) at least one anchor extending downward from the body; and
(c) securing the at least one anchor to the surface by: (i) inserting the at least one anchor between two boards of the surface or (ii) inserting the at least one anchor into the surface.

15. The method of claim 14, further comprising: hammering at least one hammer plate arranged on a top side the body to secure the at least one anchor to the surface.

16. The method of claim 14, wherein the ladder safety device comprises a rigid reinforcement member extending laterally from a bottom of the body, and wherein placing the ladder safety device against the back side of the base of the ladder comprises arranging the rigid reinforcement member to establish contact with the surface and to extend away from the base of the ladder.

17. A ladder safety device for securing a ladder on a surface, comprising:
a body; and
at least one anchor extending downward from the body such that the at least one anchor is substantially perpendicular to the surface and engages the surface when the body is placed against a base of the ladder and restricts the ladder from moving on the surface.

18. The ladder safety device of claim 17, further comprising a rigid reinforcement member extending laterally from a bottom of the body and configured to establish contact with the surface.

19. The ladder safety device of claim 18, wherein the at least one anchor and the rigid reinforcement member are substantially perpendicular.

20. The ladder safety device of claim 17, wherein the at least one anchor comprises at least two tongs, each tong of the at least two tongs having a thickness less than ⅛ inch and configured to fit between two boards of a deck.
